(19) United States
(12) Patent Application Publication
(10) Pub. No.: US 2007/0268821 A1
(43) Pub. Date: Nov. 22, 2007

(54) RPR REPRESENTATION IN OSPF-TE

(75) Inventors: Alex Levit, Ramat-Gan (IL); David Zelig, Givatayim (IL); Maxim Baranov, Raanana (IL)

Correspondence Address: DARBY & DARBY P.C., P.O. BOX 770, Church Street Station, New York, NY, 10008-0770, US

(73) Assignee: CORRIGENT SYSTEMS, LTD., Tel Aviv (IL)

(21) Appl. No.: 11/383,869

(22) Filed: May 17, 2006

(51) Int. Cl. H04J 3/14

(52) U.S. Cl. 370/223; 370/392

(57) ABSTRACT

A method for communication includes representing a layer 2 ring network, which includes two or more ring nodes interconnected by two unidirectional ringlets, as a plurality of unidirectional point-to-point links connecting respective pairs of the ring nodes and having respective traffic engineering (TE) related attributes. The TE-related attributes of the point-to-point links are distributed to routers of a communication network that includes the ring network. The distributed TE-related attributes are processed to determine an optimal routing path traversing the ring network from a source node to a destination node in the communication network.

### FIELD OF THE INVENTION

The present invention relates generally to communication networks, and particularly to methods and systems for establishing communication paths via ring networks.

### BACKGROUND OF THE INVENTION

Communication networks sometimes comprise ring configurations. For example, some networks comprise Resilient Packet Ring (RPR) configurations, as defined by the IEEE 802.17 working group. Applicable standards and additional details regarding RPR networks are available at www.ieee802.org/17.

In some cases, communication paths through a communication network are established using tunneled protocols such as the Multiprotocol Label Switching (MPLS) protocol. MPLS is described in detail by Rosen et al., in Request for Comments (RFC) 3031 of the Internet Engineering Task Force (IETF), entitled “Multiprotocol Label Switching Architecture” (January 2001), which is incorporated herein by reference. This RFC, as well as other IETF RFCs cited hereinbelow, is available at www.ietf.org/rfc.

In MPLS networks, label switched paths (LSP) are set up through the network. Network resources are reserved for LSP in the network elements and links along the path using reservation protocols. For example, a reservation protocol that may be used for this purpose, called RSVP-TE, is described by Awduche et al., in IETF RFC 3209 entitled “RSVP-TE: Extensions to RSVP for LSP Tunnels” (December 2001), which is incorporated herein by reference. RSVP-TE extends the well-known Resource Reservation Protocol (RSVP), allowing the establishment of explicitly-routed LSP using RSVP as a signaling protocol. RSVP itself is described by Braden et al., in IETF RFC 2205, entitled “Resource ReSerVation Protocol (RSVP)—Version 1 Functional Specification” (September 1997), which is incorporated herein by reference.

The routing of communication paths is sometimes determined using layer 3 routing protocols, such as the Open Shortest Path First (OSPF) protocol. OSPF is described by Moy in IETF RFC 2328, entitled “OSPF Version 2, ” April 1998, which is incorporated herein by reference. An extension of the OSPF protocol, called OSPF-TE, is described by Katz et al. in “Traffic Engineering (TE) Extensions to OSPF Version 2,” IETF RFC 3630, September 2003, which is incorporated herein by reference. OSPF-TE provides methods for describing the traffic engineering topology and distributing this information within a given network area.

Extensions to OSPF for supporting generalized MPLS are described by Kompella and Rekhter in two IETF Internet drafts entitled “OSPF Extensions in Support of Generalized Multi-Protocol Label Switching,” and “Routing Extensions in Support of Generalized Multi-Protocol Label Switching,” October 2003, which are both incorporated herein by reference. These internet drafts are available at www3.ietf.org/proceedings/03nov/I-D/draft-ietf-ccamp-ospf-gmpls-extensions-12.txt and www3.ietf.org/proceedings/03nov/I-D/draft-ietf-ccamp-gmpls-routing-09.txt, respectively.

Internet Protocol (IP) networks, and in particular protocols such as OSPF-TE, often regard ring networks as a multi-access interface that connects the nodes of the ring. The multi-access representation of RPR networks is defined by Holness and Parsons in an IETF Internet Draft entitled “Mapping of IP/MPLS Packets into IEEE 802.17 (Resilient Packet Ring) Networks,” Nov. 6, 2005, which is incorporated herein by reference. This Internet draft is available at www.ietf.org/internet-drafts/draft-ietf-iporpr-basic-01.txt.

Several methods and systems are known in the art for establishing communication paths over RPR networks. For example, U.S. Patent Application Publication 2003/0103449, whose disclosure is incorporated herein by reference, describes a method for traffic engineering in a communication system made up of network nodes arranged in multiple interconnected networks, including at least one bi-directional ring network having an inner ringlet and an outer ringlet. The bi-directional ring network is defined as a multi-access network for purposes of a routing protocol used in the system. Constraint information is advertised with regard to connections on the inner and outer rings between the nodes within the at least one bi-directional ring network. Traffic flow is routed through the system in accordance with the routing protocol, so that the flow passes through the at least one bi-directional ring network on at least one of the connections on one of the inner and outer rings that is selected responsive to the constraint information.

As another example, U.S. Patent Application Publication 2005/0213558, whose disclosure is incorporated herein by reference, describes a method and system in which routing tables of OSI layer-3 network elements are modified in order to enable entry to a RPR subnet at different entry points. The routing tables of RPR subnet elements are modified, such that traffic leaving different elements but destined for the same network location outside the RPR subnet may have individualized RPR exit nodes. The respective RPR exit points for the network elements are chosen to minimize cost factors, such as the number of RPR spans required to reach the exit node from each RPR node.

### SUMMARY OF THE INVENTION

Known layer 3 routing, distribution and reservation protocols, such as OSPF, OSPF-TE and RSVP-TE, are best suited for establishing communication paths over point-to-point links. These protocols are typically incapable of accounting for more complex layer 2 entities, such as ring networks. In particular, the multi-access interface representation of ring networks, which is often used by these layer 3 routing and distribution protocols, generally ignores the topology of the ring network and the availability of resources in its specific ringlets and segments.

In the multi-access representation, all ring nodes and the links connecting them are regarded as equal, regardless of the different number of hops separating different pairs of ring nodes or the available ring resources. As a result, routing protocols based on the multi-access representation often make non-optimal routing decisions when routing communication paths via the ring network. These non-optimal decisions may lead to poor performance and inefficient use of network resources.

In order to overcome the shortcomings of using the multi-access representation by layer 3 protocols, embodiments of the present invention provide improved methods and systems for establishing a communication path through a communication network that includes a layer 2 ring network. Instead of the known multi-access interface representation, the ring network is represented as a plurality of unidirectional point-to-point links connecting pairs of ring nodes. Each of the links has associated traffic engineering (TE) related attributes, which may comprise, for example, topology, bandwidth, administrative and/or policy-related properties of the link. The TE-related attributes of the point-to-point links are distributed to routers of the communication network, for example using OSPF-TE advertisement messages.

When establishing a communication path from a source node to a destination node in the communication network, the distributed TE-related attributes are processed to determine an optimal routing path. Using the methods described herein, the routing protocol used in the communication network is able to make better routing decisions based on TE considerations and on the actual topology of the ring network.

There is therefore provided, in accordance with an embodiment of the present invention, a method for communication, including:

representing a layer 2 ring network that includes two or more ring nodes interconnected by two unidirectional ringlets as a plurality of unidirectional point-to-point links connecting respective pairs of the ring nodes and having respective traffic engineering (TE) related attributes;

distributing the TE-related attributes of the point-to-point links to routers of a communication network that includes the ring network; and

processing the distributed TE-related attributes to determine an optimal routing path traversing the ring network from a source node to a destination node in the communication network.

In an embodiment, the ring network includes a resilient packet ring (RPR) network.

In another embodiment, the communication network includes a multiprotocol label switching (MPLS) network, and processing the TE-related attributes includes establishing a label switched path (LSP) along the optimal routing path.

In yet another embodiment, processing the TE-related attributes includes applying a layer 3 routing protocol to the TE-related attributes. The layer 3 routing protocol may include an Open Shortest Path First (OSPF) protocol. Distributing the TE-related attributes may include advertising the point-to-point links by sending open shortest path first traffic engineering (OSPF-TE) protocol advertisement messages from the ring nodes.

In an embodiment, processing the distributed TE-related attributes includes accepting a request from a user to establish a communication path between the source and destination nodes, the request including an additional routing constraint, and determining the optimal routing path based on both the distributed TE-related attributes and the additional routing constraint.

In another embodiment, each of the pairs of the ring nodes includes a first node and a second node, and representing the ring network as a plurality of unidirectional point-to-point links includes defining for each of the pairs:

a first point-to-point link representing a connection from the first node to the second node via one of the unidirectional ringlets;

a second point-to-point link representing a connection from the first node to the second node via the other of the unidirectional ringlets;

a third point-to-point link representing a connection from the second node to the first node via the one of the unidirectional ringlets; and

a fourth point-to-point link representing a connection from the second node to the first node via the other of the unidirectional ringlets.

In yet another embodiment, the TE-related attributes associated with a link include at least one of:

a maximum bandwidth of the link;

a maximum reservable bandwidth of the link;

a currently available bandwidth in the link;

an identifier indicating a ringlet used by the link;

a number of hops traversed by the link;

an estimate of a round-trip time (RTT) over the link;

a traffic metric indicating a TE-related cost of passing a routing path over the link;

a policy-related attribute; and

an administrative affiliation of the link.

In still another embodiment, distributing the TE-related attributes includes obtaining up-to-date values of at least some of the TE-related attributes from one of the ring nodes serving as a master ring node.

In an embodiment, processing the TE-related attributes includes allocating resources of the communication network along the optimal routing path responsively to the TE-related attributes. Allocating the resources may include allocating the resources of the ring network along a part of the optimal routing path traversing the ring network by one of the ring nodes serving as a bandwidth broker (BWB).

There is additionally provided, in accordance with an embodiment of the present invention, a method for communication, including:

configuring a layer 2 multi-access network so that network resources are allocated to traffic flows through the multi-access network such that each traffic flow is confined to a respective part of the layer 2 multi-access network;

representing the layer 2 multi-access network as a plurality of unidirectional point-to-point links connecting respective pairs of nodes of the multi-access network and having respective traffic engineering (TE) related attributes;

distributing the TE-related attributes of the point-to-point links to routers of a communication network that includes the multi-access network; and

processing the distributed TE-related attributes to determine an optimal routing path traversing the multi-access network from a source node to a destination node in the communication network.

There is also provided, in accordance with an embodiment of the present invention, apparatus for use as a ring node in a layer 2 ring network that includes two or more ring nodes interconnected by two unidirectional ringlets, the apparatus including:

a network interface, which is arranged to communicate with other ring nodes of the ring network over the two unidirectional ringlets; and

a processor, which is arranged to represent at least a part of the ring network that is connected to the ring node as a plurality of unidirectional point-to-point links having respective traffic engineering (TE) related attributes, and to distribute the TE-related attributes to routers of a communication network including the ring network so as to enable the routers to determine an optimal routing path traversing the ring network from a source node to a destination node in the communication network.

There is further provided, in accordance with an embodiment of the present invention, a communication network, including:

two or more ring nodes; and

two unidirectional communication ringlets connecting the ring nodes, the ringlets and ring nodes forming a layer 2 ring network,

wherein at least one of the ring nodes is arranged to represent at least part of the ring network connected thereto as a plurality of unidirectional point-to-point links having respective traffic engineering (TE) related attributes, and to distribute the TE-related attributes to routers of the communication network so as to enable the routers to determine an optimal routing path traversing the ring network from a source node to a destination node in the communication network.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a communication network, in accordance with an embodiment of the present invention;

FIG. 2 is a block diagram that schematically illustrates a ring network represented using point-to-point links, in accordance with an embodiment of the present invention; and

FIG. 3 is a flow chart that schematically illustrates a method for establishing a communication path, in accordance with an embodiment of the present invention.

### DETAILED DESCRIPTION OF EMBODIMENTS

### System Description

FIG. 1 is a block diagram that schematically illustrates a communication network 20, in accordance with an embodiment of the present invention. Network 20 comprises an Internet Protocol (IP) network in which network elements (NE) 24, also referred to as network nodes, communicate with one another. Nodes 24 may comprise routers, servers, bridges or any other network elements known in the art. In the description that follows, network 20 comprises an MPLS network and nodes 24 comprise label switched routers (LSR). Alternatively, network 20 and nodes 24 may operate in accordance with other suitable network types and protocols. In the example of FIG. 1, network 20 comprises five nodes denoted 24A . . . 24E, although the methods and systems described herein can be used in networks having any number of nodes.

At least some of the nodes of network 20 are connected by a layer 2 ring network 28. In the example of FIG. 1, ring network 28 connects network nodes 24A . . . 24D, which are referred to as ring nodes. In some embodiments, network 20 may comprise nodes that are not part of ring 28, such as node 24E in FIG. 1. Alternatively, all of nodes 24 may comprise ring nodes connected by ring 28. Ring network 28 comprises two unidirectional ringlets oriented in opposite directions, referred to as a clockwise (CW) ringlet 32 and a counterclockwise (CCW) ringlet 36. In some embodiments, ring 28 comprises an RPR network, in accordance with the IEEE 802.17 standard cited above. Alternatively, ring 28 may conform to other ring configurations, such as, for example, the Spatial Reuse Protocol/Dynamic Packet Transport (SRP/DPT) ring network products offered by Cisco Systems, Inc. (San Jose, Calif.). Details regarding SRP/DPT are available at www.cisco.com/en/US/tech/tk482/tk611/tsd_technology_support_protocol_home.html. SRP is also described by Tsiang and Suwala in IETF RFC 2892 entitled “The Cisco SRP MAC layer protocol,” August 2000, which is incorporated herein by reference.

Each ring node comprises a network interface 40 for communicating with other ring nodes over ring 28. In some embodiments, such as in nodes 24A and 24B, interface 40 is also used for communicating with network nodes outside of ring 28. Each ring node comprises a processor 44, which carries out, inter alia, methods related to establishing communication paths through network 20, as described below. Processor 44 may comprise a general-purpose computer, which is programmed in software to carry out the functions described herein. The software may be downloaded to the computer in electronic form, over a network, for example, or it may alternatively be supplied to the computer on tangible media, such as CD-ROM. Alternatively, processor 44 may comprise one or more hardware logic components (hard-wired or programmable) or a combination of hardware- and software-implemented elements.

In some embodiments, at least one of the ring nodes comprises a bandwidth broker (BWB) module 48, which carries out resource (e.g., bandwidth) reservation functions for the entire ring network. These functions are also referred to as ring-level connection admission control (CAC) functions. In some embodiments, BWB 48 provides the ring nodes with up-to-date information regarding resource allocations in the ring network, to enable distribution of the TE-related attributes. This process is described in greater detail further below.

CAC and bandwidth allocation methods in ring configurations are described, for example, in U.S. Patent Application Publication 2004/0085899 A1, whose disclosure is incorporated herein by reference. Resource reservation methods and other traffic engineering aspects in ring networks are also described in U.S. Pat. No. 6,963,537 and in U.S. Patent Application Publication 2003/0103449 A1, whose disclosures are incorporated herein by reference. Another exemplary bandwidth manager is described by Yavatkar et al. in IETF RFC 2814 entitled “SBM (Subnet Bandwidth Manager): A Protocol for RSVP-Based Admission Control over IEEE 802-Style Networks,” May 2000, which is incorporated herein by reference.

Typically, BWB 48 is implemented as a software process or thread running on processor 44. In some embodiments, the BWB functionality is active in only one of nodes 24, i.e., only one bandwidth broker is active in ring network 28 at any given time.

### Routing Communication Paths Via RPR Networks

Some IP networks use layer 3 protocols, such as the OSPF and OSPF-TE protocols cited above, for determining the routing of a communication path between a source node and a destination node through the network. In principle, the OSPF-TE protocol distributes (“advertises”) TE-related information of communication links in the network using link state advertisement (LSA) messages. Network nodes that support OSPF-TE, typically comprising layer 3 routers, can use this information to determine an optimal routing path, taking into account the TE-related information as constraints. Typically, each node stores the advertised information in a TE database (TED) 50.

When a request is accepted to establish a new communication path from a source node to a destination node, the source node determines the optimal routing path based on the TE-related information stored in TE database 50. In some embodiments, the source node may take into account additional constraints specified in the request when determining the optimal routing path.

Once the optimal path is determined, resources (e.g., bandwidth) are reserved in the nodes and/or links along the path using a reservation protocol such as RSVP-TE. Thus, in an MPLS network, OSPF, OSPF-TE and RSVP-TE are used to set up a unidirectional label switched path (LSP), also referred to as an MPLS tunnel, from the source to the destination node.

Although the embodiments described herein mainly refer to the routing of LSP using OSPF, OSPF-TE and RSVP-TE, the disclosed methods and systems can also be used with other distribution, routing and/or reservation protocols. For example, the methods and systems described herein can be used with the Intermediate System to Intermediate System (IS-IS) link state protocol and its extension for traffic engineering (IS-IS-TE). These protocols are described by Smit and Li in “Intermediate System to Intermediate System (IS-IS) Extensions for Traffic Engineering (TE),” IETF RFC 3784, June 2004, and by Kompella and Rekhter (editors) in “Intermediate System to Intermediate System (IS-IS) Extensions in Support of Generalized Multi-Protocol Label Switching (GMPLS),” IETF RFC 4205, October 2005, which are incorporated herein by reference.

However, known layer 3 routing and reservation protocols are best suited for establishing communication paths over point-to-point links and are incapable of accounting for more complex layer 2 entities, such as ring networks. For example, as noted above, RPRs are typically represented in IP networks as multi-access interfaces. The multi-access interface representation does not preserve the topological structure of the RPR, i.e., the fact that it comprises two ringlets and the different hop distances between different ring nodes. The multi-access representation also does not address the available resources on the different ring segments and ringlets. All this information, which may significantly affect routing decisions through the ring, is lost.

### Representation of RPR Using Point-to-Point Links

The methods and systems described herein enable the use of distribution and routing protocols such as OSPF-TE and OSPF over ring networks, while preserving the ring topology and the traffic engineering (TE) related attributes of the different ring segments and ringlets. In principle, the RPR network is first represented as a plurality of point-to-point links that connect pairs of ring nodes. The point-to-point links are advertised, or distributed across the network, in accordance with the OSPF-TE protocol. Each point-to-point link is associated with one or more TE-related attributes, as will be described in detail below. The TE-related attributes are distributed as part of the link advertisement messages.

Nodes 24 of network 20 receive the OSPF-TE advertisement (LSA) messages. The nodes use the TE-related attributes carried in the messages to construct and update TE database 50. Thus, each node 24 maintains an up-to-date database of the advertised links 20 and their TE-related attributes. Generally, an arbitrary node 24 does not distinguish between point-to-point links that are part of the representation of ring network 28 and between other point-to-point links of network 20 unrelated to the ring.

The representation of ring network 28 as a plurality of point-to-point links thus provides detailed information regarding the routing options through the ring network to nodes 24. When a particular node 24 is required to make a routing decision, for example using OSPF, the node takes into account the advertised TE-related attributes, and is thus able to make better routing decisions. Note that link representation and advertisement can be carried out using standard OSPF-TE mechanisms, without modification.

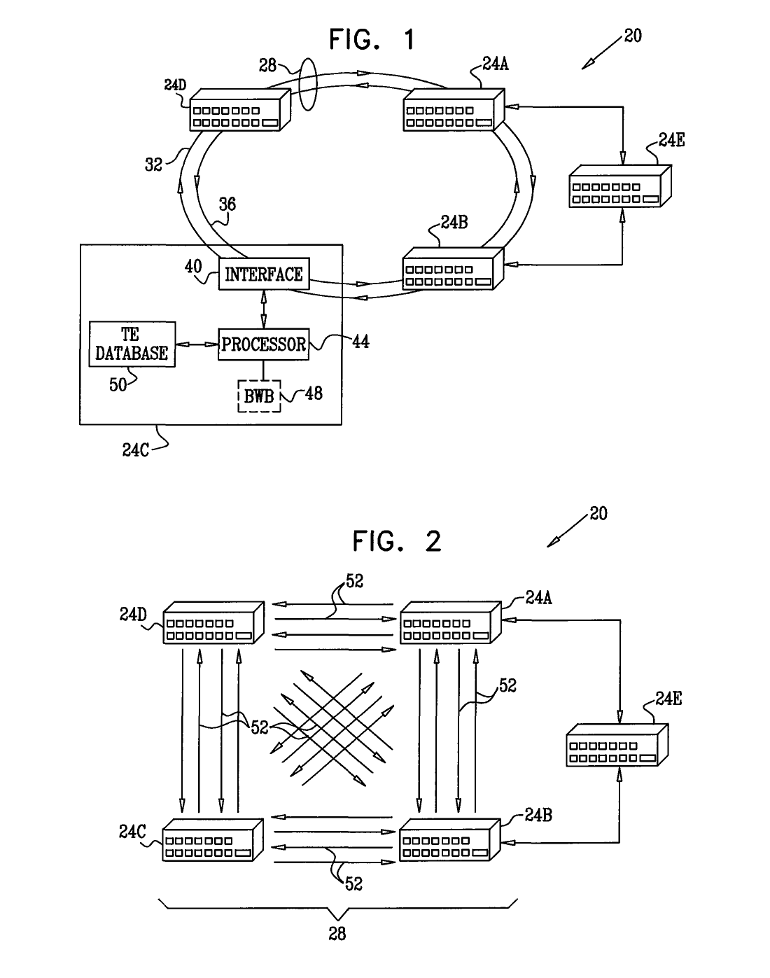

FIG. 2 is a block diagram that schematically illustrates ring network 28 of FIG. 1 above represented using point-to-point links 52, in accordance with an embodiment of the present invention. In the representation shown in FIG. 2, each pair of ring nodes is connected by four unidirectional point-to-point links 52, two links in either direction.

Each link 52 corresponds to an alternative path, which may be chosen through the ring. Consider, for example, the alternative paths that may be chosen to connect ring nodes 24A and 24B. Traffic can be sent from node 24A to node 24B over two alternative paths: (1) directly over CW ringlet 32, or (2) via nodes 24D and 24C over CCW ringlet 36. Similarly, traffic from node 24B to node 24A can also be sent over two alternative paths: (1) directly over CCW ringlet 36, or (2) via nodes 24C and 24D over CW ringlet 32. Thus, the connectivity between ring nodes 24A and 24B can be represented using a total of four unidirectional point-to-point links 52. Note that some of links 52 represent physical paths that traverse several network segments and ring nodes. The collection of links 52 thus fully preserves the topology of RPR network 28.

Each link 52 has one or more TE-related attributes. In the context of the present patent application and in the claims, the term “TE-related attribute” is used to describe any link property that may affect a decision to route or to refrain from routing a communication path through it. For example, TE-related attributes may comprise a maximum bandwidth of the link (also referred to as the link capacity or link rate), a definition of the maximum reservable bandwidth (which may be different from the link capacity, for example when allowing a certain amount of overbooking), and/or a currently available (unreserved) bandwidth over the link.

Some TE-related attributes may be related to the ring topology. For example, an attribute may identify the ringlet (e.g., CW ringlet 32 or CCW ringlet 36) used by the link in question. Another attribute may comprise the number of hops (ring segments) traversed by the link. In some embodiments, an attribute may comprise an estimate of the round-trip time (RTT) over the link, which is conventionally measured in RPR networks. Other TE-related attributes may have an administrative nature or have to do with certain network policies. For example, attributes may define the security status of the link, a metric indicating the cost of passing traffic over the link, and/or an indication that the link belongs to a different service provider or even to a different country. Additionally or alternatively, any other suitable link property can be used as a TE-related attribute.

In some embodiments, each ring node transmits OSPF-TE advertisement messages advertising the outgoing links 52 that are directed from it to the other ring nodes. In other words, for every pair of ring nodes denoted X and Y. node X advertises two unidirectional point-to-point links directed from it to node Y. one link traversing CW ringlet 32 and one link traversing CCW ringlet 36. Although in OSPF-TE and other TE protocols the ring nodes typically advertise their outgoing links, the methods described herein are not limited to advertising outgoing links, and can be similarly used with protocols in which each ring node advertises the inbound links directed to it from the other ring nodes.

OSPF-TE advertisement messages allow for optional type length value (TLV) fields. When distributing the TE-related attributes, the messages may carry at least some of the following data is TLV fields and/or sub-fields:

An identifier marking the advertised link as a point-to-point link (as opposed to a multi-access link).

A local IP address identifying the RPR interface of the node transmitting the message. This value is typically configured manually by an administrator as part of the configuration of the ring node.

A remote IP address identifying the RPR interface of the ring node to which the advertised link is directed. This value is typically determined automatically by the advertising ring node from RPR topology messages, as specified in IEEE 802.17 cited above.

A traffic engineering (TE) metric. This field gives a quantitative TE-related metric or weight, indicating the desirability of including the advertised link in a communication path. For example, a TE metric may comprise the number of hops traversed by the link, assuming that using short links in the routing path is preferable over using longer links. Another TE metric may comprise the RPR round-trip time (RTT) estimate described above, which also gives more weight to shorter links. Various policy-related or administrative attributes described above can also be used as TE metrics.

The maximum bandwidth of the advertised link.

The maximum reservable bandwidth over the advertised link. This value may be greater than the maximum bandwidth when a certain amount of overbooking is allowed over the link, in accordance with a predetermined overbooking profile.

The currently available bandwidth over the advertised link.

An indication of the ringlet used by the advertised link. Since the two unidirectional links connecting a pair of ring nodes (over the two ringlets) have identical local and remote IP addresses, this field can be used to distinguish between links traversing the CW and the CCW ringlets.

An identifier indicating the affiliation of the advertised link to a particular administrative group. For example, Awduche et al. describe the use of administratively assigned parameters referred to as resource class attributes in “Requirements for Traffic Engineering over MPLS,” IETF RFC 2702, September 1999, section 6.2, page 21, which is incorporated herein by reference.

Some of the TE-related attributes can be defined manually by a user, such as a network administrator or designer. Other attributes can be determined automatically by the advertising ring node. For example, in RPR networks, the number of hops traversed by a particular link can be measured automatically using the topology messages transmitted among the ring nodes. The total link capacity can also be deduced automatically using the physical layer properties known to the advertising ring node.

In some embodiments, each ring node obtains and maintains the information required for advertising its respective outgoing links, and advertises them without coordination with the other ring nodes. In these embodiments, each ring node should be aware of the current ring topology and the current status of bandwidth allocations over the entire ring network.

In alternative embodiments, one of the ring nodes is defined as a master. The master ring node obtains and maintains the TE-related information required for advertising all point-to-point links of the ring network. The master updates the other ring nodes with the up-to-date link status, so as to enable them to advertise their respective outgoing links correctly. A hybrid configuration, in which some of the TE-related attributes are determined locally by the advertising node and some attributes are provided by the master ring node, can also be used.

Typically, the ring node that currently operates bandwidth broker 48 is also chosen to serve as the master for maintaining advertisement-related information. When establishing a new communication path, the master ring node approves the resource allocations in the ring for the selected path. Typically, any of the ring nodes is capable of carrying out the master functionality, but only one master is active at any given time. If the current master fails, another ring node may replace it. Any suitable logic can be used to select the currently-active master or replace a failed master.

In order to reduce processing overhead in network nodes, the OSPF and OSPF-TE protocols allow the network to be partitioned into areas. LSA messages and OSPF/OSPF-TE operation in general do not cross area boundaries. In these scenarios, the advertisement of point-to-point links 52 of ring 28 is also limited to the area containing ring network 28.

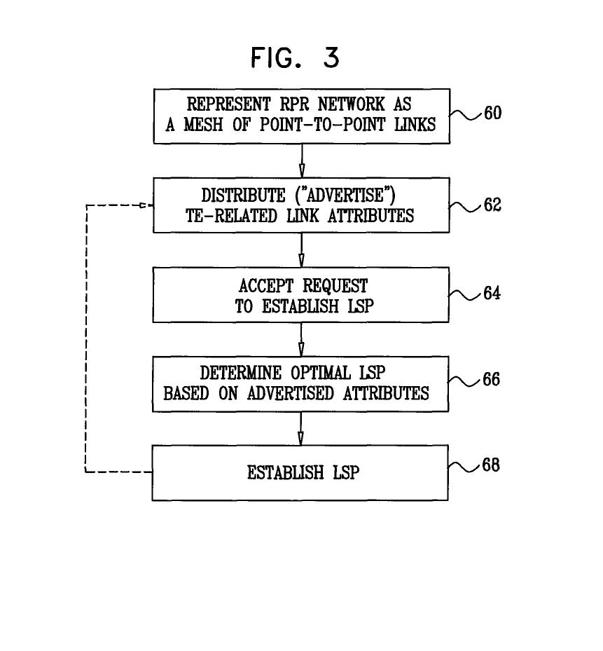

FIG. 3 is a flow chart that schematically illustrates a method for establishing a communication path, in accordance with an embodiment of the present invention. The method begins by representing RPR network 28 as a plurality of point-to-point links 52, at a representation step 60. Each ring node defines two outgoing point-to-point links between itself and each of the other ring nodes. In total, four unidirectional links 52 are defined between each pair of ring nodes, as shown in FIG. 2 above. Each ring node associates one or more TE-related attributes with each of its outgoing links.

Each ring node advertises its respective outgoing links by transmitting OSPF-TE advertisement (LSA) messages, at an advertising step 62. The advertisement messages comprise the TE-related attributes, thereby distributing the attributes to nodes of network 20. In general, the attributes are distributed both to the other ring nodes and to nodes outside ring network 28, if such nodes exist. The different nodes of network 20 receive the advertised links and attributes, and use them to update their TE databases 50.

When it is required to set up a new communication path (a LSP in the present example) from a source node to a destination node in network 20, a request is accepted at the source node, at a request acceptance step 64. In general, it is assumed that the optimal routing path traverses ring network 28, although the source and destination nodes may comprise any node in network 20, and not necessarily ring nodes in network 28. The source node determines the optimal routing path to the destination node, at a path determination step 66. The source node determines the optimal path based on its locally-stored TE database 50, which was previously constructed and updated with the TE-related attributes advertised at step 62 above. As noted above, the source node may also take into account additional constraints when determining the optimal routing path. These constraints are typically specified in the request, but may alternatively be defined in advance.

The source node then establishes the communication path using the optimal routing, at a path establishment step 68. As part of the path establishment, resources are reserved in the different nodes and links along the path, for example using the RSVP-TE protocol. Within ring network 28, resources are typically reserved by bandwidth broker 48.

Referring, for example, to FIGS. 1 and 2 above, consider a new LSP that should be established from node 24E to node 24D. There are four alternative paths that should be considered:

24E→24A→24D (via CCW ringlet 36).

24E→24A→24B→24C→24D (via CW ringlet 32).

24E→24B→24A→24D (via CCW ringlet 36).

24E→24B→24C→24D (via CW ringlet 32).

Using the advertised link attributes, source node 24E has all the information necessary to apply OSPF-TE and select, out of the four alternative paths, the optimal path to destination node 24D.

In some cases, TE-related attributes change over time. When such changes affect the TE-related attributes of one or more of point-to-point links 52, the method may return to advertising step 62 above in order to re-advertise the links whose TE-related attributes have changed.

Although the embodiments described herein mainly refer to the establishment of MPLS LSP over RPR networks using OSPF-TE, the methods and systems described herein can also be used in other applications, such as the IS-IS and IS-IS-TE protocols cited above.

Additionally or alternatively to ring networks, the methods and systems described herein can be used for representing and communicating over any layer 2 multi-access network in which resources are allocated in only part of the network. In such resource allocation mechanisms, network resources (e.g., bandwidth) are allocated to a particular packet or traffic flow in only a subset of the network's segments or topology. Since packets or traffic flows are confined to particular areas of the network, they do not consume the entire multi-access medium. Thus, a more efficient use of network resources is achieved. For example, resource allocation mechanisms may be employed in various local area network (LAN) configurations. In such configurations, the logical topology is typically different from the physical topology of the network.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for communication, comprising:
representing a layer 2 ring network that includes two or more ring nodes interconnected by two unidirectional ringlets as a plurality of unidirectional point-to-point links connecting respective pairs of the ring nodes and having respective traffic engineering (TE) related attributes;
distributing the TE-related attributes of the point-to-point links to routers of a communication network that includes the ring network; and
processing the distributed TE-related attributes to determine an optimal routing path traversing the ring network from a source node to a destination node in the communication network.

2. The method according to claim 1, wherein the ring network comprises a resilient packet ring (RPR) network.

3. The method according to claim 1, wherein the communication network comprises a multiprotocol label switching (MPLS) network, and wherein processing the TE-related attributes comprises establishing a label switched path (LSP) along the optimal routing path.

4. The method according to claim 1, wherein processing the TE-related attributes comprises applying a layer 3 routing protocol to the TE-related attributes.

5. The method according to claim 4, wherein the layer 3 routing protocol comprises an Open Shortest Path First (OSPF) protocol.

6. The method according to claim 5, wherein distributing the TE-related attributes comprises advertising the point-to-point links by sending open shortest path first traffic engineering (OSPF-TE) protocol advertisement messages from the ring nodes.

7. The method according to claim 1, wherein processing the distributed TE-related attributes comprises accepting a request from a user to establish a communication path between the source and destination nodes, the request comprising an additional routing constraint, and determining the optimal routing path based on both the distributed TE-related attributes and the additional routing constraint.

8. The method according to claim 1, wherein each of the pairs of the ring nodes comprises a first node and a second node, and wherein representing the ring network as a plurality of unidirectional point-to-point links comprises defining for each of the pairs:
a first point-to-point link representing a connection from the first node to the second node via one of the unidirectional ringlets;
a second point-to-point link representing a connection from the first node to the second node via the other of the unidirectional ringlets;
a third point-to-point link representing a connection from the second node to the first node via the one of the unidirectional ringlets; and
a fourth point-to-point link representing a connection from the second node to the first node via the other of the unidirectional ringlets.

9. The method according to claim 1, wherein the TE-related attributes associated with a link comprise at least one of:
a maximum bandwidth of the link;
a maximum reservable bandwidth of the link;
a currently available bandwidth in the link;
an identifier indicating a ringlet used by the link;
a number of hops traversed by the link;
an estimate of a round-trip time (RTT) over the link;
a traffic metric indicating a TE-related cost of passing a routing path over the link;
a policy-related attribute; and
an administrative affiliation of the link.

10. The method according to claim 1, wherein distributing the TE-related attributes comprises obtaining up-to-date values of at least some of the TE-related attributes from one of the ring nodes serving as a master ring node.

11. The method according to claim 1, wherein processing the TE-related attributes comprises allocating resources of the communication network along the optimal routing path responsively to the TE-related attributes.

12. The method according to claim 11, wherein allocating the resources comprises allocating the resources of the ring network along a part of the optimal routing path traversing the ring network by one of the ring nodes serving as a bandwidth broker (BWB).

13. A method for communication, comprising:
configuring a layer 2 multi-access network so that network resources are allocated to traffic flows through the multi-access network such that each traffic flow is confined to a respective part of the layer 2 multi-access network;
representing the layer 2 multi-access network as a plurality of unidirectional point-to-point links connecting respective pairs of nodes of the multi-access network and having respective traffic engineering (TE) related attributes;
distributing the TE-related attributes of the point-to-point links to routers of a communication network that includes the multi-access network; and
processing the distributed TE-related attributes to determine an optimal routing path traversing the multi-access network from a source node to a destination node in the communication network.

14. The method according to claim 13, wherein processing the TE-related attributes comprises applying an Open Shortest Path First (OSPF) protocol to the TE-related attributes.

15. The method according to claim 13, wherein distributing the TE-related attributes comprises obtaining up-to-date values of at least some of the TE-related attributes from one of the nodes of the multi-access network serving as a master node.

16. Apparatus for use as a ring node in a layer 2 ring network that includes two or more ring nodes interconnected by two unidirectional ringlets, the apparatus comprising:
a network interface, which is arranged to communicate with other ring nodes of the ring network over the two unidirectional ringlets; and
a processor, which is arranged to represent at least a part of the ring network that is connected to the ring node as a plurality of unidirectional point-to-point links having respective traffic engineering (TE) related attributes, and to distribute the TE-related attributes to routers of a communication network comprising the ring network so as to enable the routers to determine an optimal routing path traversing the ring network from a source node to a destination node in the communication network.

17. The apparatus according to claim 16, wherein the ring network comprises a resilient packet ring (RPR) network.

18. The apparatus according to claim 16, wherein the communication network comprises a multiprotocol label switching (MPLS) network and wherein the optimal routing path comprises a label switched path (LSP).

19. The apparatus according to claim 16, wherein the part of the ring network that is connected to the ring node comprises at least one neighbor ring node, and wherein the processor is arranged to represent a connectivity of the ring node to the neighbor ring node by defining:
a first point-to-point link representing a connection from the ring node to the neighbor ring node via one of the unidirectional ringlets;
a second point-to-point link representing a connection from the ring node to the neighbor ring node via the other of the unidirectional ringlets;
a third point-to-point link representing a connection from the neighbor ring node to the ring node via the one of the unidirectional ringlets; and
a fourth point-to-point link representing a connection from the neighbor ring node to the ring node via the other of the unidirectional ringlets.

20. The apparatus according to claim 16, wherein the TE-related attributes associated with a link comprise at least one of:
a maximum bandwidth of the link;
a maximum reservable bandwidth of the link;
a currently available bandwidth in the link;
an identifier indicating a ringlet used by the link;
a number of hops traversed by the link;
an estimate of a round-trip time (RTT) over the link;
a traffic metric indicating a TE-related cost of passing a routing path over the link;
a policy-related attribute; and
an administrative affiliation of the link.

21. The apparatus according to claim 16, wherein the processor is arranged to obtain up-to-date values of at least some of the TE-related attributes from another ring node in the ring network serving as a master ring node.

22. The apparatus according to claim 16, wherein the processor is arranged to advertise the point-to-point links by sending open shortest path first traffic engineering (OSPF-TE) protocol advertisement messages.

23. The apparatus according to claim 16, wherein the processor is arranged to allocate resources of the ring network along a part of the optimal routing path traversing the ring network responsively to the TE-related attributes.

24. A communication network, comprising:
two or more ring nodes; and
two unidirectional communication ringlets connecting the ring nodes, the ringlets and ring nodes forming a layer 2 ring network,
wherein at least one of the ring nodes is arranged to represent at least part of the ring network connected thereto as a plurality of unidirectional point-to-point links having respective traffic engineering (TE) related attributes, and to distribute the TE-related attributes to routers of the communication network so as to enable the routers to determine an optimal routing path traversing the ring network from a source node to a destination node in the communication network.

25. The communication network according to claim 24, wherein the ring network comprises a resilient packet ring (RPR) network.

26. The communication network according to claim 24, wherein the communication network comprises a multiprotocol label switching (MPLS) network and wherein the optimal routing path comprises a label switched path (LSP).

27. The communication network according to claim 24, wherein the at least one of the ring nodes is arranged to advertise the point-to-point links by sending open shortest path first traffic engineering (OSPF-TE) protocol advertisement messages.

28. The communication network according to claim 24, wherein the at least one of the ring nodes is arranged to obtain up-to-date values of at least some of the TE-related attributes from another one of the ring nodes serving as a master ring node.

29. The communication network according to claim 24, wherein one of the ring nodes is arranged to allocate resources of the ring network along a part of the optimal routing path traversing the ring network responsively to the TE-related attributes.
